(19) United States
(12) Patent Application Publication
(10) Pub. No.: US 2013/0002586 A1
(43) Pub. Date: Jan. 3, 2013

(54) MODE SWITCH METHOD OF MULTI-FUNCTION TOUCH PANEL

(76) Inventor: Yun-Yu Kung, Taipei (TW)

(21) Appl. No.: 13/537,492

(22) Filed: Jun. 29, 2012

(30) Foreign Application Priority Data
Jul. 1, 2011 (CN) 201110183524.5

(51) Int. Cl. G06F 3/041

(52) U.S. Cl. 345/173

(57) ABSTRACT

The mode switching method of multi-function touch panel comprises a touch panel receiving a touch signal and identifying whether the touch signal is a multi-touch signal; if the touch signal is a multi-touch signal, the multi-function touch panel performing multi-touch mode; if the touch signal is not a multi-touch signal, the multi-function touch panel is going to determine whether performing functional mode switch; if determining to perform functional mode switch, the multi-function touch panel will chose to enter keyboard set mode or transform gesture mode; if determined not to perform functional mode switch, the multi-function touch panel will check the touch signal belong to keyboard mode, mouse mode, or other mode, and respectively perform identifying keyboard input, mouse mode, or controlling the single-touch gesture detective and switch mode.

### BACKGROUND OF THE INVENTION

1. Field of the Invention

The present invention is generally related to a switch method, and more particularly to a mode switch method of multi-function touch panel.

2. Description of the Prior Art

Touch panel is widely used in the touch monitor of portable device, such as mobile phone, computer, and other electronic devices. The general operation of computer and other calculating machine is changed by touch panel. Touch panel is easy for operating, and connects people and machine interface directly. The fast development of touch panel is replacing the operating interface constructed of mechanical keyboard and traditional mouse.

Especially for Google's Android and Apple's IOS system, the operating software is based on touch control, including absolute touch coordinate, virtual keyboard (assistive touch), touch control gesture and so on. The operating software is widely employed by software creators. At the same time, Microsoft Co. starts supporting touch control and gesture application from system from Window 7.

Besides, with informatizing and intellectualizing of household appliances, smart house platform is more and more common for household appliances, for example, the combination of computing device and television, the universal of smart television, and the connection of computing device and large size monitor. Wireless computer input device gradually develops from the original desktop operating environment including keyboard and mouse to a friendly operating environment with touch input system. A remote control device with simply station-selecting and sound-adjusting is gradually integrated with the functions of touch information, mouse event, and text input, and the mentioned functions cannot be achieved by a traditional remote control device.

Particularly, for appliance remote controller with wireless input device, the mentioned remote controller is used to transmit messages through wireless mode to some stationary device, such as television, air conditioner, computer, and so on. Presently, a remote controller majorly transmits messages to the related apparatus by limited control signal, such as changing channel, controlling cold-warm conditioner. So that the presently remote controller needs substantive buttons, and low transmitting speed, such as infrared rays. Moreover, the presently remote controller is demanded to keep in contact with the related machine without any barrier between the remote controller and the related apparatus.

Another feature of wireless input remote controller is that the remote controller is hand-held and operated with one hand or both hands, so that the mentioned remote controller does not need any supporting member or be operated with a stationary position. Oppositely, keyboard and mouse of a computer need to be operated on a supported plane surface, so that normal input device as keyboard and mouse cannot be applied directly on intellectualizing household appliances. With the popularization of touch system and touch device, it is necessary to provide switch-able touch control function for portable input device for wireless remote control.

Under the dimensions limitation, the existing hand-held input device, including portable and laptop device, keyboard, small touch panel, mechanical or optical wheel as mouse are integrated into one case. The defect of the above-mentioned hand-held input device is that the effective area for operating each single function is too limited. The keyboard area is too small. The touch control area is too small. The single wheel area cannot attain touch control operation. For intellectualizing household appliances, with increasing messages, expending new buttons for more function controls, and adding optical wheel for mouse actions, the mentioned defect of hand-held input device also exists in the present remote controller of intellectualizing household appliances. For the above reasons, it is need to improve the present touch control technology for achieving perfect switch among different functions.

### SUMMARY OF THE INVENTION

In view of the above background and in order to fulfill the requirements of industry, a new design of a mode switch method of multi-function touch panel is provided in the present invention.

In order to overcome the mentioned defects, this present invention discloses a mode switch method of multi-function touch panel. The mode switch method of multi-function touch panel comprises the steps of: (1) a multi-function touch panel receiving a touch signal and identifying whether the touch signal is a multi-touch signal; (2) if the touch signal is a multi-touch signal, the multi-function touch panel explaining the touch signal as a multi-touch signal and performing multi-touch mode; (3) if the touch signal is not a multi-touch signal, the multi-function touch panel going to determine whether performing function mode switch, if determining to perform functional mode switch, the multi-function touch panel going to chose entering keyboard setting mode or gesture transforming mode, wherein the multi-function touch panel is going to perform keyboard setting in the keyboard setting mode, wherein the multi-function touch panel is going to translate different gestures in the gesture transforming mode; (4) if determining not to perform functional mode switch in the step (3), the multi-function touch panel going to check whether the touch signal belongs to keyboard mode, mouse mode, or other mode; (5) if the touch signal in step (4) is keyboard mode, the multi-function touch panel going to activate and identify keyboard input operation; (6) if the touch signal in step (4) is mouse mode, the multi-function touch panel going to activate the function of the left and right input elements of mouse and perform mouse input operation; (7) if the touch signal in step (4) is indentified as other mode, the multi-function touch panel going to perform controlling and detecting single-touch gesture switch mode. The mentioned multi-touch control gesture comprises magnifying/minifying with two fingers, sliding, and strike-slipping with two fingers. In the above mentioned step (3), when entering keyboard set mode, the multi-function touch panel will display keyboard. In the above mentioned step (3), when entering gesture transforming mode, the multi-function touch panel can also display joystick control mode. The commands in each mode of the multi-function touch panel of this invention can be transmitted through wireless form. The adventure of the mode switch method of this invention is that the size of the device with the mentioned touch panel is suitable for handled by one or both hands and the full area of the touch panel can be employed by all switch-able functions of the touch panel as keyboard, mouse, and touch control. That is, most surface area of the device with the touch panel are touch panel and for those switch-able functions through this invention. When switching the touch panel into remote controller mode, the touch panel becomes touch input interface, and the touch panel can be operated with general finger gestures and real-time input complex mouse coordinate. The touch panel according to this invention can perform multi-functions at the same time. The touch panel can provide usually functional input key and touch control coordinate panel at the same time, intelligently process different input data, respectively aim at the processing collected touch data, and maximally utilize the surface area of the touch panel. The touch panel of this invention also can integrate keyboard into touch panel under keyboard setting mode, and achieve fast switch between keyboard/mouse modes through shortcut. According to this invention, the touch panel can provide maximum functions without losing the adventure of a hand-held device. The adventure can be extended to multimedia gesture mode and joystick mode, so that this invention can perfectly accomplish the target of multi-functions in one device.

### BRIEF DESCRIPTION OF THE DRAWINGS

FIG. 1 shows a flowchart of mode switch method of multi-function touch panel of the present invention.

### DETAILED DESCRIPTION OF THE PREFERRED EMBODIMENTS

What is probed into the invention is mode switch method of multi-function touch panel. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

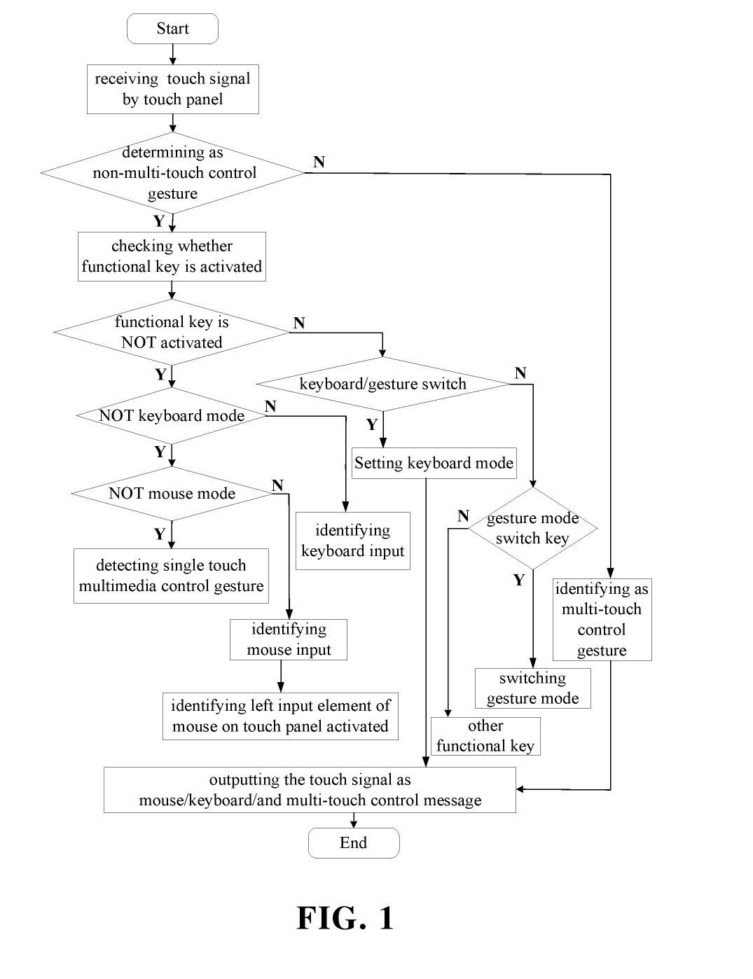

FIG. 1 is a flowchart of a mode switch method of multi-function touch panel of this invention. Referred to FIG. 1, when starting, a multi-function touch panel is in ready for receiving touch signal. When receiving a touch signal, the multi-function touch panel is going to identify whether the touch signal is a multi-touch signal. If the touch signal is a multi-touch signal, the multi-function touch panel is going to explain the touch signal as a multi-touch control gesture and perform multi-touch control mode. If the touch signal is identified not a multi-touch signal, the multi-function touch panel is further going to determine whether performing function mode switch. In one preferred example of this invention, as shown in FIG. 1, a functional key is employed to concretely present that the mentioned multi-function touch panel determining whether performing function mode switch. That is, when the functional key is triggered off, the multi-function touch panel is going to enter function mode switch. After entering function switch mode, the multi-function touch panel is going to select entering keyboard setting mode or gesture transforming mode. Upon user's requirement and selection, the multi-function touch panel is going to perform keyboard setting in the keyboard setting mode, and translate different gestures in the gesture transforming mode. If not entering function mode switch, the multi-function touch panel is going to check whether the touch signal belongs to keyboard mode, mouse mode, or other mode. The multi-function touch panel is going to activate and identify keyboard input operation in the keyboard mode. The multi-function touch panel going to activate the function of the left and right input elements of mouse and perform mouse input operation in the mouse mode. If the touch signal is indentified as other mode, the multi-function touch panel is going to perform controlling and detecting single-touch gesture switch mode. When switching into each different mode, the multi-function touch panel is going to show different display respectively relative to the switch mode. According to this invention, the signal(s)/command(s) in each switch mode of the multi-function touch panel can be sent with wireless form to target apparatus with wireless receiver. Concretely, the multi-touch control gesture comprises magnifying/minifying with two fingers, sliding, and strike-slipping with two fingers. In one preferred example of this invention, joystick is also one concrete form of the multi-touch control gesture mode.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A mode switch method of multi-function touch panel comprising:
(1) receiving a touch signal by a touch panel, and identifying whether the touch signal is a multi-touch signal by the touch panel;
(2) determining the touch signal as a multi-touch control gesture if the touch signal is a multi-touch signal, wherein the multi-function touch panel subsequently performs multi-touch mode;
(3) determining whether performing functional mode switch if the touch signal is not a multi-touch signal, wherein if performing functional mode switch, the multi-function touch panel enters keyboard setting mode or gesture transforming mode, wherein the multi-function touch panel performs keyboard setting in keyboard setting mode, wherein the multi-function touch panel performs translates different gestures in gesture transforming mode;
(4) checking whether the touch signal belonging to keyboard mode, mouse mode, or other mode if the multi-function touch panel in said (3) does not perform function mode switch;
(5) identifying keyboard input if the multi-function touch panel in said (4) determines the touch signal as keyboard mode;
(6) activating left and right input elements of mouse and performing mouse input operation if the multi-function touch panel determines the touch signal as mouse mode in said (4); and
(7) performing single-touch gesture switch mode if the multi-function touch panel determines the touch signal as other mode in said (4).

2. The mode switch method of multi-function touch panel according to claim 1, wherein the multi-touch control gesture comprises magnifying/minifying with two fingers, sliding, and strike-slipping with two fingers.

3. The mode switch method of multi-function touch panel according to claim 1, wherein the multi-function touch panel displays keyboard when entering keyboard setting mode.

4. The mode switch method of multi-function touch panel according to claim 1, wherein the gesture transforming mode in said step (3) comprises joystick control mode.

5. The mode switch method of multi-function touch panel according to claim 1, wherein the multi-function touch panel can transmit signal(s)/command(s) in each switch mode of the multi-function touch panel to target apparatus with wireless receiver.
